(19) United States
(12) Patent Application Publication
(10) Pub. No.: US 2004/0093938 A1
(43) Pub. Date: May 20, 2004

(54) Liquid in pipeline and liquid level detection and warning system

(76) Inventors: Chung-Te Tsai, Miaoli (TW); Chin-Chao Cheng, Hsinchu (TW); Ming-Xian Lin, Taipei (TW); Deng-Shun Liao, Tainan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,752

(22) Filed: Nov. 15, 2002

(51) Int. Cl. G01F 23/00; G08B 21/00

(52) U.S. Cl. 73/290 R; 340/612

(57) ABSTRACT

A liquid in pipeline and liquid level detection and warning system and some of its applications are provided. The liquid in pipeline and liquid level detection and warning system is incorporated into a liquid delivery unit. The liquid delivery unit includes a pipeline serially linking a liquid tank, a buffer tank and liquid outlet element. A drainage unit is also positioned under the outlet element for collecting redundant liquid. The warning and detection system includes a liquid in pipeline warning system and a liquid level warning system. The liquid in pipeline warning system has a first liquid in pipeline sensor installed on the pipeline between the buffer tank and the outlet element and a second liquid in pipeline sensor installed on the pipeline between the liquid tank and the buffer tank. The liquid level warning system has a first and a second liquid level sensor installed on the drainage unit such that the second liquid level sensor is positioned below the first liquid level sensor.

### BACKGROUND OF INVENTION

1. Field of Invention

The present invention relates to a semiconductor fabrication tool and its application. More particularly, the present invention relates to a liquid in pipeline and liquid level detection and warning system.

2. Description of Related Art

In the fabrication of semiconductor devices, various types of liquids are required in different processes. For example, in a photoresist (PR) coating process, photoresist material is sprayed on the surface of a wafer before conducting a photolithographic process.

Most photoresist coating stations include a number of units all serially connected through a pipeline. The pipeline links up a photoresist tank for holding liquid photoresist, a buffer tank for preventing the formation of air bubbles when the photoresist tank is empty, a pump for pumping liquid photoresist and a nozzle for ejecting liquid photoresist. In addition, the photoresist coating station may include a receptacle for holding wafers underneath the nozzle and a barrel underneath the receptacle for draining away liquid photoresist dripping from the wafers.

To detect the amount of photoresist remaining, a liquid sensor is often installed along a section of the pipeline between the buffer tank and the nozzle for detecting the amount of liquid inside the buffer tank. When all the liquid within the buffer tank is gone, the liquid sensor along the pipeline will detect the absence of liquid and stop any on-going operation. The photoresist coating station may resume operation only after the emptied tanks are refilled. However, the wafer within the processing machine may or may not have completed the photoresist coating operation when the station is stopped. Consequently, the batch of wafers within the processing station may need to be reworked before conducting another photoresist coating operation.

In addition, a conventional station may also use a liquid level sensor to detect the amount of liquid photoresist inside the barrel. When the amount of liquid photoresist inside the barrel almost overflows, the liquid level sensor will again stop the on-going operation within the station. The photoresist coating station will resume operation only after the excessive liquid photoresist within the barrel is cleared. Similarly, the batch of wafers within the station may or may not have completed the photoresist coating operation. In other words, this batch of wafers may have to be reworked.

In the aforementioned conditions, that is, when liquid photoresist within the buffer tank is used up or when the liquid photoresist within the barrel starts to overflow, the processing station has to be stopped and the batch of processing wafers within the station has to be reworked. Hence, with this setup, not only is the throughput of the station lowered, production cost and cycle time is also increased as well. Furthermore, if the liquid in pipeline sensor or the barrel liquid level sensor should malfunction, liquid photoresist depletion occurring in the pipeline or drain overflow in the barrel may not be detected at all. Ultimately, this may lead to more serious consequences.

### SUMMARY OF INVENTION

Accordingly, one object of the present invention is to provide a liquid in pipeline and liquid level detection and warning system capable of detecting the amount of liquid photoresist still present and continuing with photoresist coating operation on a batch of wafers even when the amount of liquid photoresist runs low. Hence, the batch of wafers inside the photoresist coating station has no need to be reworked.

A second object of this invention is to provide a liquid in pipeline and liquid level detection and warning system capable of detecting the amount of liquid photoresist inside the drainage barrel of a photoresist coating station. Furthermore, the batch of wafers inside the photoresist coating station has no need to rework even if the machine is shut down.

A third object of this invention is to provide a liquid in pipeline and liquid level detection and warning system that removes the need for any wafer reworking after a photoresist coating operation inside a photoresist coating station. Thus, overall throughput is increased while production cost and cycle time is reduced.

A fourth object of this invention is to provide a liquid in pipeline and liquid level detection and warning system capable of preventing the serious consequences that may result from a mal-function of liquid in pipeline sensor or the liquid level sensor in a conventional photoresist coating station.

To achieve these and other advantages and in accordance with the purpose of the invention, as embodied and broadly described herein, the invention provides a liquid in pipeline and liquid level detection and warning system suitable for a liquid delivery unit. The liquid delivery unit includes a pipeline that sequentially links up a liquid tank, a buffer tank for preventing the formation of air bubbles when the liquid tank is depleted, a pipe outlet through which liquid is expelled from the pipeline and a drainage element underneath the liquid outlet for collecting excess liquid flowing from the pipe outlet. The liquid in pipeline and liquid level detection and warning system includes a liquid in pipeline warning system and a liquid level warning system. The liquid in pipeline warning system includes a first liquid in pipeline sensor installed between the buffer tank and the pipe outlet and a second liquid in pipeline sensor installed between the liquid tank and the buffer tank. The liquid level warning system includes a first liquid level sensor and a second liquid level sensor mounted on the drainage element such that the second liquid level sensor is positioned slightly below the first liquid level sensor.

The warning system of this invention may be modified according to the actual circumstances. In one application, for example, the liquid in pipeline and liquid level detection and warning system in the liquid delivery unit may have just one liquid level sensor installed on the drainage element close to the outlet of the drainage element aside from a first liquid in pipeline sensor between the buffer tank and the pipe outlet and a second liquid in pipeline sensor between the liquid tank and the buffer tank. In an alternative application, the warning system may have two liquid level sensors installed on the drainage element but just one liquid in pipeline sensor between the buffer tank and the pipe outlet.

This invention also provides a method of detecting liquid in pipeline and liquid level and issuing a warning message when the liquid is depleted or the liquid level is low. The method is implemented using the aforementioned detection and warning system. First, the second liquid in pipeline sensor is used to detect the presence of any liquid within the pipeline. When the pipeline contains no liquid, which implies all the liquid inside the liquid tank is used up, the liquid tank can be replaced or refilled without stopping the machine. After replacement of refilling, the second liquid in pipeline sensor is again used to detect the presence of any liquid within the pipeline. On the other hand, if the second liquid in pipeline sensor is able to detect liquid within the pipeline, the first liquid in pipeline sensor is used to detect the presence of any liquid within the pipeline.

When the first liquid in pipeline sensor detects the absence of liquid within the pipeline, which is abnormal in normal circumstances, the first liquid in pipeline sensor must be checked for any failure. If the first liquid in pipeline sensor really malfunctions, the sensor must be repaired. However, if the first liquid in pipeline sensor is found to be normal after inspection, the second liquid in pipeline sensor or all the installations between the first liquid in pipeline sensor to the liquid tank must be checked to find out the problem. After finding and rectifying the problem, the second liquid in pipeline sensor resumes the checking of liquid within the pipeline. Conversely, if the first liquid in pipeline sensor is able to sense liquid inside the pipeline, both the first and the second liquid in pipeline sensors are operating normally.

Thereafter, the second liquid level sensor is used to determine if the liquid has reached that level. If the liquid level reaches this position, this means too much liquid has dropped into a barrel used for collecting liquid in the drainage element. Hence, it is time to flush out the liquid. After flushing the liquid, the second liquid level sensor resumes liquid level detection. On the other hand, if the second liquid level sensor detects no approaching liquid level, the first liquid level sensor is used to detect liquid level position. When the first liquid in pipeline sensor detects an approaching liquid level in the barrel, which is abnormal in normal circumstances, the first liquid level sensor must be checked for any failure. If the first liquid level sensor mal-functions, the sensor is repaired. If the first liquid level sensor is perfectly normal, then the second liquid level sensor needs to be inspected to find out the actual problem. On resolving the problem, the second liquid level sensor resumes its normal liquid level detection function. Conversely, if the first liquid level sensor detects no approaching liquid level, this indicates both the first and the second liquid level sensor are working normally. This completes the detection process. However, the aforementioned steps are not the only detection flow pattern. In fact, the detection flow pattern may be amended according to any modification in the detection and warning system.

This invention utilizes the first liquid in pipeline sensor positioned between the buffer tank and the outlet element and the second liquid in pipeline sensor positioned between the liquid tank and the buffer tank to determine the amount of liquid in the liquid tank and the buffer tank simultaneously. When the second liquid in pipeline sensor detects the absence of liquid within the liquid tank, the liquid tank can be replaced or refilled without shutting down the machine because the buffer tank still contains sufficient amount of liquid. Since there is no need to stop the machine, no rework is required for the batch of wafers inside the operating chamber of the machine. Ultimately, throughput of the processing machine is increased while the production cost and cycle time of wafer fabrication is reduced. Furthermore, if one of the two sensors along the pipeline fails, problems can be sorted out before anything serious occurs to the batch of processing wafers due to the absence of liquid such as photoresist to the processing chamber.

In addition, this invention also provides a first and a second liquid level sensor mounted on the barrel of a drainage element such that the second liquid level sensor is positioned slightly below the first liquid level sensor. When the liquid within the barrel reaches a position detectable by the second liquid level sensor, the processing operation may be carried through to completion because some time is still left before the liquid inside the barrel reaches the overflow level. Hence, the exhaust liquid in the barrel is flushed out only after completing all necessary operations. Without stopping the machine prematurely, no wafers inside the processing chamber need to be reworked. Ultimately, throughput of the processing machine is increased while the production cost and cycle time of wafer fabrication is reduced. Furthermore, if one of the two liquid level sensors in the barrel fails, problems can be sorted out before anything serious like flooding the processing chamber with exhaust liquid occurs.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram showing the layout of a photoresist coating station according to one preferred embodiment of this invention; and

FIG. 2 is a flow chart showing the steps carried out by a liquid in pipeline and liquid level detection and warning system within the photoresist coating station shown in FIG. 1.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

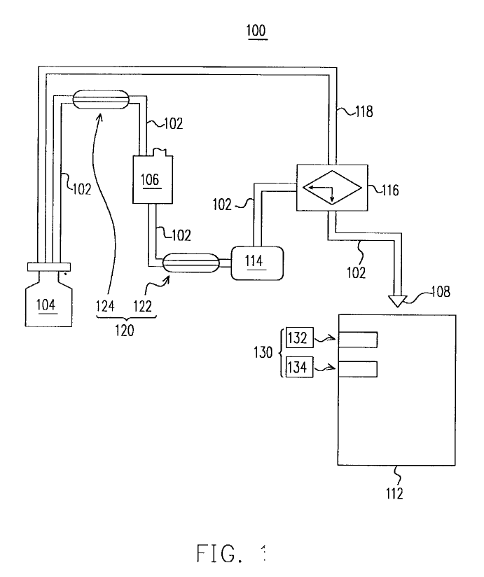

In this invention, a liquid in pipeline and liquid level detection and warning system is applied to a station for conducting photoresist (PR) coating. FIG. 1 is a schematic diagram showing the layout of a photoresist coating station according to one preferred embodiment of this invention. As shown in FIG. 1, the photoresist coating station 100 at least includes a pipeline 102 that serially connects with a photoresist tank 104 for holding liquid photoresist, a buffer tank 106 for preventing the formation of air bubbles when the photoresist tank 104 is empty, a nozzle 108 for expelling photoresist from the pipeline 102, a receptacle 110 for holding wafers underneath the nozzle 108 and a barrel 112 underneath the receptacle 110 for collecting redundant photoresist dripping from the wafers.

The photoresist coating station 100 further includes a liquid in pipeline warning system 120 and a liquid level warning system 130. The liquid in pipeline warning system 120 includes a first liquid in pipeline sensor 122 installed between the buffer tank 106 and the nozzle 108 and a second liquid in pipeline sensor 124 installed between the photoresist tank 104 and the buffer tank 106. The liquid level warning system 130 includes a first liquid level sensor 132 and a second liquid level sensor 134 installed on the side of the barrel 112 for collecting redundant liquid photoresist. The second liquid level sensor 134 is positioned under the first liquid level sensor 132.

Other accessory components in the photoresist coating station 100 include a pump 114 installed between the first liquid in pipeline sensor 122 and the nozzle 108 for pumping liquid photoresist and a three-way valve 116 installed between the first liquid in pipeline sensor 122 and the nozzle 108 having an additional pipeline 118 branching to the photoresist tank 104. The three-way valve 116 facilitates the return of liquid photoresist back to the photoresist tank 104 when the photoresist tank 104 is replaced or the flushing of air bubbles from the pipeline 102, thereby saving some photoresist.

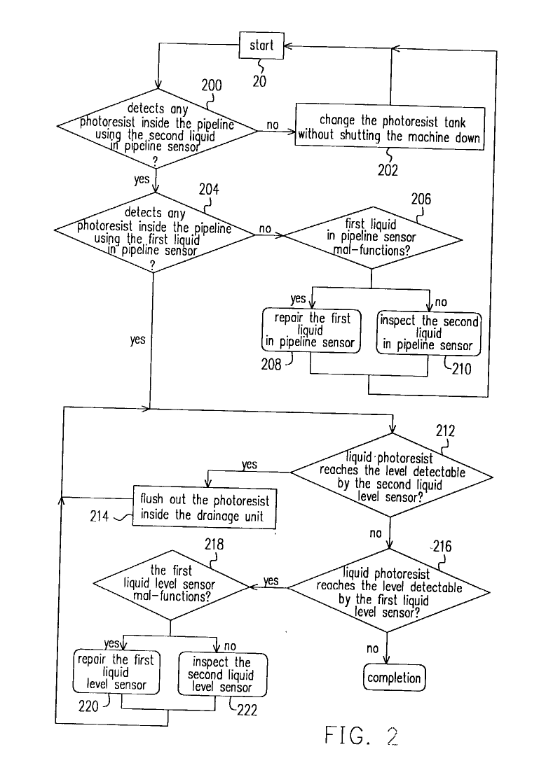

FIG. 2 is a flow chart showing the steps carried out by a liquid in pipeline and liquid level detection and warning system within the photoresist coating station shown in FIG. 1. In step 200, the second liquid in pipeline sensor 124 is used to detect any liquid photoresist in the pipeline 102. If the second liquid in pipeline sensor 124 detects the absence of photoresist within the pipeline 102, this means that all the photoresist within the photoresist tank 104 is used up. The photoresist tank 104 is replaced or refilled without shutting down the station in step 202. Since the buffer tank 106 still contains sufficient amount of liquid photoresist, the station may continue to operate while the photoresist tank 104 is replaced or refilled. Without shutting down the station, no reworking is required and hence throughput of the station is increased while production cost and cycle time is reduced. Thereafter, control is returned to step 20 and the detection of liquid in the pipeline 102 is resumed. On the contrary, if the second liquid in pipeline sensor 124 detects the presence of liquid photoresist within the pipeline 102, step 204 is carried out.

In step 204, the first liquid in pipeline sensor 122 is used to detect liquid photoresist within the pipeline 102. If the first liquid in pipeline sensor 122 detects the absence of photoresist within the pipeline 102, which is abnormal for a normal operation, step 206 is carried out to check if the first liquid in pipeline sensor 122 is functioning normally or not. If the first liquid in pipeline sensor 122 somehow mal-functions, the first liquid in pipeline sensor 122 is repaired in step 208. However, if the first liquid in pipeline sensor 122 functions normally, the second liquid in pipeline sensor 124 and/or all other components between the first liquid in pipeline sensor 122 and the photoresist tank 104 are inspected in step 210 to find out the actual problem. Once the problem is found and sorted out, control is returned to step 20 so that the detection of liquid in the pipeline 102 is resumed. Conversely, if the first liquid pipeline sensor 122 detects the presence of photoresist inside the pipeline 102, this means that both the first and the second liquid in pipeline sensors 122, 124 are working normally and can proceed with step 212.

In step 212, the second liquid level sensor 134 is used to detect the liquid level within the barrel 112. if the second liquid level sensor 134 detects the arrival of a liquid level, this indicates time has come to remove some of the liquid photoresist within the barrel 112. The liquid photoresist inside the barrel 112 is flushed out in step 214. Since the barrel 112 still has the capacity to collect some more liquid photoresist before it overflows, there is sufficient time to finish coating the batch of wafers inside the station 100 before stopping the station to flush out the unwanted photoresist in the barrel 112. Thus, no reworking is required after the flushing. Ultimately, throughput of the station is increased while production cost and cycle time is reduced. Thereafter, control is returned to step 212 and the detection of liquid level by the second liquid level sensor 134 within the barrel 112 is re-initiated. On the other hand, if the second liquid level sensor 134 detects no arriving liquid level, the first liquid level sensor 132 is used to detect the arrival of a liquid level in step 216. If the first liquid level sensor 132 detects the arrival of a liquid level in the barrel 112, which is abnormal for a normal operation, step 218 is carried out to check if the first liquid level sensor 132 is functioning normally or not. If the first liquid level sensor 132 somehow malfunctions, the first liquid level sensor 132 is repaired in step 220. However, if the first liquid level sensor 132 functions normally, the second liquid level sensor 134 is inspected in step 222 to find out the actual problem. Once the problem is found and sorted out, control is returned to step 212 so that the detection of liquid level within the barrel 112 is resumed. On the contrary, if the first liquid level sensor 132 detects no approaching liquid level in the barrel 112, this means that both the first and the second liquid level sensors 132, 134 are working normally. This terminates the cycle of liquid in pipeline and liquid level detection.

The flow chart in FIG. 2 illustrates only one of the possible routes through which the detection and warning system operates. If the detection and warning system is somehow modified to meet a particular operating environment, the steps needed to check liquid in pipeline and liquid level in the barrel in the flow may be adjusted accordingly. For example, if there is only one liquid level sensor in the barrel for detecting liquid level position, steps 216˜222 can be omitted so that step 214 may be carried out or the detection is simply terminated after carrying out step 212. Alternatively, if there is only one liquid in pipeline sensor installed between the buffer tank and the nozzle, steps 204˜210 may be omitted so that step 212 or step 202 for replacing the photoresist tank is carried out after step 200.

In summary, major aspects of this invention include:

1. This invention utilizes the first liquid in pipeline sensor positioned between the buffer tank and the outlet element and the second liquid in pipeline sensor positioned between the liquid tank and the buffer tank to determine the amount of liquid in the liquid tank and the buffer tank simultaneously. When the second liquid in pipeline sensor detects the absence of liquid within the liquid tank, the liquid tank can be replaced or refilled without shutting down the machine because the buffer tank still contains sufficient amount of liquid. Since there is no need to stop the machine, throughput of the processing machine is increased while the production cost and cycle time of wafer fabrication is reduced.

2. If one of the two sensors along the pipeline fails, problems can be sorted out before anything serious occurs to the batch of processing wafers due to the absence of liquid such as photoresist to the processing chamber.

3. This invention also provides a first and a second liquid level sensor mounted on the barrel of a drainage element such that the second liquid level sensor is positioned slightly below the first liquid level sensor. When the liquid within the barrel reaches a position detectable by the second liquid level sensor, the processing operation may be carried through to completion because some time is still left before the liquid inside the barrel reaches the overflow level. Hence, the exhaust liquid in the barrel is flushed out only after completing all necessary operations. Without stopping the machine prematurely, no wafers inside the processing chamber need to be reworked. Ultimately, throughput of the processing machine is increased while the production cost and cycle time of wafer fabrication is reduced.

4. Since two liquid level sensors are used, problems can be sorted out before anything serious like flooding the processing chamber with exhaust liquid occurs if one of the two liquid level sensors in the barrel fails.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A liquid in pipeline and liquid level detection and warning system for a liquid delivery unit, wherein the liquid delivery unit includes a pipeline that links up serially with a liquid tank for holding a processing liquid, a buffer tank for preventing the formation of air bubbles in the pipeline when the liquid tank is depleted, an outlet element for outputting liquid from the pipeline and a drainage unit underneath the outlet element, the system comprising:
a liquid in pipeline warning system having:
a first liquid in pipeline sensor installed on the pipeline between the buffer tank and the outlet element; and
a second liquid in pipeline sensor installed on the pipeline between the liquid tank and the buffer tank; and
a liquid level warning system having:
a first liquid level sensor for detecting the liquid level in the drainage unit,
wherein the first liquid level sensor has a first sensing position; and
a second liquid level sensor for detecting a second liquid level in the drainage unit, wherein the second liquid level sensor is installed below the first sensing position.

2. The detection and warning system of claim 1, wherein the liquid delivery unit includes the delivery system of a photoresist coating station.

3. The detection and warning system of claim 2, wherein the liquid tank includes a photoresist tank.

4. The detection and warning system of claim 2, wherein the outlet element includes a nozzle.

5. The detection and warning system of claim 4, wherein the photoresist coating station further includes a receptacle underneath the nozzle for holding wafers.

6. The detection and warning system of claim 5, wherein the drainage unit includes a barrel underneath the receptacle for holding redundant photoresist dripping from the wafers.

7. A liquid in pipeline and liquid level detection and warning system for a liquid delivery unit, wherein the liquid delivery unit includes a pipeline that links up serially with a liquid tank for holding a processing liquid, a buffer tank for preventing the formation of air bubbles in the pipeline when the liquid tank is depleted, an outlet element for outputting liquid from the pipeline and a drainage unit underneath the outlet element, the system comprising:
a liquid in pipeline warning system having:
a first liquid in pipeline sensor installed on the pipeline between the buffer tank and the outlet element; and
a second liquid in pipeline sensor installed on the pipeline between the liquid tank and the buffer tank; and
a liquid level sensor installed in the drainage unit with a sensing position, and the sensing position being close to the outlet of the drainage unit.

8. The detection and warning system of claim 7, wherein the liquid delivery unit includes the delivery system of a photoresist coating station.

9. A liquid in pipeline and liquid level detection and warning system for a liquid delivery unit, wherein the liquid delivery unit includes a pipeline that links up serially with a liquid tank for holding a processing liquid, a buffer tank for preventing the formation of air bubbles in the pipeline when the liquid tank is depleted, an outlet element for outputting liquid from the pipeline and a drainage unit underneath the outlet element, the system comprising:
a liquid in pipeline warning system having:
a liquid in pipeline sensor installed on the pipeline between the buffer tank and the outlet element; and
a liquid level warning system having:
a first liquid level sensor installed inside the drainage unit, wherein the first liquid level sensor has a first sensing position; and
a second liquid level sensor installed inside the drainage unit, wherein the second liquid level sensor has a second sensing position, and the second sensing position is lower than the first sensing position.

10. The detection and warning system of claim 9, wherein the liquid delivery unit includes the delivery system of a photoresist coating station.

11. A method of detecting liquid in pipeline and liquid level and issuing a warning signal in a liquid in pipeline and liquid level detection and warning system according to claim 1, comprising the steps of:
(a) using the second pipeline in liquid sensor to detect the presence of liquid in the pipeline, if no liquid is detected inside the pipeline, step (b) below is executed, otherwise, step (c) below is executed;
(b) replacing the liquid tank without shutting down the processing station and executing step (a) thereafter;
(c) using the first liquid in pipeline sensor to detect the presence of liquid in the pipeline, if no liquid is detected inside the pipeline, step (d) below is executed, otherwise, step (g) below is executed;
(d) checking the first liquid in pipeline sensor to determine if it mal-functions, if the first liquid in pipeline sensor malfunctions, step (e) below in executed, otherwise, step (f) below is executed;
(e) repairing the first liquid in pipeline sensor and executing step (a) thereafter;
(f) inspecting the second liquid in pipeline sensor and executing step (a) thereafter;
(g) using the second liquid level sensor to determine if the liquid level has reached the second sensor position, if the liquid level has not yet reached the second liquid level, step (i) below is executed, otherwise, step (h) below is executed;
(h) flushing out the liquid inside the drainage unit and executing step (g) thereafter;
(i) using the first liquid level sensor to determine if the liquid level has reached the first sensor position, if the liquid level has reached the first liquid level, step (j) below is executed, otherwise, the process of detecting liquid in pipeline and liquid level is finished;
(j) inspecting the first liquid level sensor to determine if its mal-functions, if the first liquid level sensor really mal-functions, step (k) below is executed, otherwise, step (l) below is executed;
(k) repairing the first liquid level sensor and executing step (g) thereafter; and
(l) inspecting the second liquid level sensor and executing step (g) thereafter.

12. The method of claim 11, wherein step (f) further includes inspecting all the devices installed between the first liquid in pipeline sensor and the liquid tank.

13. A method of detecting liquid in pipeline and liquid level and issuing a warning signal in a liquid in pipeline and liquid level detection and warning system according to claim 7, comprising the steps of:
(a) using the second pipeline in liquid sensor to detect the presence of liquid in the pipeline, if no liquid is detected inside the pipeline, step (b) below is executed, otherwise, step (c) below is executed;
(b) replacing the liquid tank without shutting down the processing station and executing step (a) thereafter;
(c) using the first liquid in pipeline sensor to detect the presence of liquid in the pipeline, if no liquid is detected inside the pipeline, step (d) below is executed, otherwise, step (g) below is executed;
(d) checking the first liquid in pipeline sensor to determine if it mal-functions, if the first liquid in pipeline sensor mal-functions, step (e) below in executed, otherwise, step (f) below is executed;
(e) repairing the first liquid in pipeline sensor and executing step (a) thereafter;
(f) inspecting the second liquid in pipeline sensor and executing step (a) thereafter;
(g) using the liquid level sensor to determine if the liquid level has reached the sensor position, if the liquid level has reached the second liquid level, step (h) below is executed, otherwise, the process of detecting liquid in pipeline and liquid level is finished; and
(h) flushing out the liquid inside the drainage unit and executing step (g) thereafter.

14. The method of claim 13, wherein step (f) further includes inspecting all the devices installed between the first liquid in pipeline sensor and the liquid tank.

15. A method of detecting liquid in pipeline and liquid level and issuing a warning signal in a liquid in pipeline and liquid level detection and warning system according to claim 9, comprising the steps of:
(a) using the pipeline in liquid sensor to detect the presence of liquid in the pipeline, if no liquid is detected inside the pipeline, step (b) below is executed, otherwise, step (c) below is executed;
(b) replacing the liquid tank without shutting down the processing station and executing step (a) thereafter;
(c) using the second liquid level sensor to determine if the liquid level has reached the second sensor position, if the liquid level has not yet reached the second liquid level, step (e) below is executed, otherwise, step (d) below is executed;
(d) flushing out the liquid inside the drainage unit and executing step (c) thereafter;
(e) using the first liquid level sensor to determine if the liquid level has reached the first sensor position, if the liquid level has reached the first liquid level, step (f) below is executed, otherwise, the process of detecting liquid in pipeline and liquid level is finished;
(f) inspecting the first liquid level sensor to determine if it mal-functions, if the first liquid level sensor really malfunctions, step (g) below is executed, otherwise, step (h) below is executed;
(g) repairing the first liquid level sensor and executing step (c) thereafter; and
(h) inspecting the second liquid level sensor and executing step (c) thereafter.
